(19) United States
(12) Patent Application Publication
(10) Pub. No.: US 2016/0263857 A1
(43) Pub. Date: Sep. 15, 2016

(54) KNIT SPACER FABRICS AND MOTOR-VEHICLE INTERIOR

(71) Applicant: Mueller Textiol GmbH, Wiehl-Drabenderhoehe (DE)

(72) Inventors: Stefan MUELLER, Wiehl (DE); Frank MUELLER, Wiehl (DE)

(21) Appl. No.: 15/150,640

(22) Filed: May 10, 2016

Related U.S. Application Data
(63) Continuation-in-part of application No. 13/913,080, filed on Jun. 7, 2013, now abandoned.

(30) Foreign Application Priority Data
Jun. 13, 2012 (DE) 102012105134.8

(51) Int. Cl. B32B 5/06; B32B 5/02; B32B 3/26; B32B 5/26; D04B 1/02; D04B 1/10

(52) U.S. Cl. CPC B32B 5/06; D04B 1/02; D04B 1/102; B32B 3/266; B32B 5/26; B32B 5/026; D10B 2403/022; D10B 2505/12; B32B 2605/003; B32B 2307/554

(57) ABSTRACT

A spacer fabric has first and second generally planar knitted layers that are attached to each other by spacer threads. These spacer threads form in the first knitted layer stitches by an intertwining of threads, and do not form stitches in the second generally planar knitted layer but are interlaced there only as an inlay.

### CROSS REFERENCE TO RELATED APPLICATIONS

This application is a continuation-in-part of copending patent application Ser. No. 13/913,080 filed 7 Jun. 2013 with a claim to the priority of German patent application 10 2012 105 134.8 filed 13 Jun. 2012.

### FIELD OF THE INVENTION

The invention relates to a spacer fabric comprising a first and second generally planar knitted layer that are attached to each other by spacer threads.

### BACKGROUND OF THE INVENTION

Generic spacer fabrics have been disclosed, for example, in DE 199 03 070 and DE 90 16 062. The known spacer fabrics are employed as soft, elastic layers, and layers that provide air circulation, in mattresses, upholstered furniture, items of clothing, or shoes. In addition, spacer fabrics find widespread use in the automotive field, such as, for example, for climate-controlled seats and seat covers where the spacer fabrics allow for effective adaptation to contours due to their superior recovery properties. For example, spacer fabrics are thus an alternative, for example, to foam padding where a wear-resistant cover layer of leather or cloth is typically provided.

In the known spacer fabrics, the spacer threads are interlaced in the same way in both knitted layers, specifically, such that spacer threads in the first knitted layer and in the second knitted layer form stitches due to the intertwining of threads. The spacer threads here are intertwined with each other and/or with the threads of the knitted layers. The formation of stitches in the knitted layers enables the spacer threads to be strongly interlaced and aligned, thereby providing the requisite compressive strength.

Despite the fact that spacer fabrics have proven quite successful in practical use, there remains a need to enhance their resistance to mechanical stresses. The known spacer fabrics, in particular, entail the danger that individual threads can be pulled out under mechanical stress, thereby degrading the spacer fabrics both in terms of appearance and functionality. This danger exists, in particular, whenever the spacer fabrics are exposed to pointed objects or even hook-and-loop fasteners that are often used in items of clothing.

For practical applications, padding materials undergo hook-and-loop fastener tests in which the sensitivity of padding materials are tested by a procedure approximating real use for wear and tear caused by hook-and-loop fasteners. Based on DIN EN ISO 12947-1, the German Automotive Industry Association (VDA) has issued Test Specification VDA 230-210 of December 2008. The test sample is subjected to applied stresses by a hook strip, type 751, after which an assessment is made by visual inspection and a grade is given based on five grade levels. No changes to the surface results in a score of grade 5, whereas complete destruction of the surface and the structure is assessed with a grade of 1. Based on this referenced test specification, the goal is a grade of 5 for a padding material that is suitable for long-term use in a motor vehicle, and this goal is difficult to achieve using known spacer fabrics, with the result that the known designs of vehicle seats are always provided with an additional cover layer such as one composed, for example, of cloth, leather, or artificial leather.

### OBJECT OF THE INVENTION

In light of the above, the object of this invention is to provide a spacer fabric that has enhanced resistance to wear from mechanical stresses. In particular, the object is to provide a spacer fabric that can also be employed as a cover layer for a motor vehicle interior where this spacer fabric does not structurally degrade when used in the motor vehicle.

### SUMMARY OF THE INVENTION

Based on a spacer fabric having the above-described features, the object of the invention is attained in that the spacer threads do not form stitches on the second generally planar knitted layer and are only interlaced there as an inlay. What is understood by this within the scope of the invention is that the spacer threads are held on the second knitted layer by at least one associated thread without thereby forming a stitch by intertwining. The spacer threads are thus threaded through in each case on at least one thread of the second knitted layer.

The second generally planar knitted layer in the spacer fabric according to the invention is provided as the exterior wear layer that is exposed to mechanical stresses, for example, hook-and-loop fasteners. The fact that the spacer threads are interlaced only as an inlay prevents a situation where these threads run along the exposed surface of the second knitted layer, and can thereby be caught by hook-and-loop hooks or other pointed objects and pulled out. Since the spacer threads are interlaced only as an inlay, these threads can run along the inside of the second knitted layer with the result that the threads of the second knitted layer essentially cover and thus protect the spacer threads.

An additional advantage to be considered is the fact that the spacer threads in the described embodiment are also not visible on the exposed surface of the second knitted layer. One aspect that must be considered here is that different thread types are typically used for a thread system of the second knitted layer on the one side and for the spacer threads on the other side. As a result, the spacer threads often are monofilaments so as to achieve a high compressive strength, whereas multifilaments are preferably used for the cover layers. Within the scope of the invention, multifilament flat yarn is, in particular, well-suited for the second generally planar knitted layer, as such yarn thus does not swell out and accordingly has no texture.

In terms of the different described thread types for the second generally planar knitted layer and for the spacer threads, it is not possible to easily match these precisely for color. In addition to the color per se, another visual effect is also achieved. Since the spacer threads according to the invention are interlaced only on the inside as an inlay on the second generally planar knitted layer, these threads are not visible and cannot result in visual variation compared with the threads of the second knitted layer.

It is of critical importance for the invention that the spacer threads in the first knitted layer on the one hand and in the second knitted layer on the other hand are interlaced differently. Since the spacer threads in the first knitted layer form stitches due to thread intertwining either with each other and/or with the threads of the first knitted layers, it is possible to achieve superior resistance under load for the spacer threads. The spacer threads here preferably form pile loops between the knitted layers, which loops have loop feet created by stitches or knots in the first knitted layer, and loop heads between the pile loops, the pile loops on the loop heads being held on the second knitted layer.

The second knitted layer according to the invention can have a knit pattern having a perforated structure. This perforated structure is both visually attractive and is also especially well suited for dissipating moisture and water vapor. In order, however, to ensure that relatively large particles of dirt or the like cannot penetrate into the spacer fabric, according to a preferred development of the invention holes of the perforated structure on the inside of the second knitted layer are covered by separate threads, in particular, by weft threads that run perpendicular to the knit direction. The shape of the holes according to the invention can vary. They can be round, oval, rhombic, or roughly rectangular.

Since the perforated structure can be generated with high uniformity, these weft threads can be matched in terms of color to the thread system of the second generally planar knitted layer, or can also optionally be of contrasting color. A color contrast provides an especially easy way to produce an attractive and vivid design.

If the spacer fabric has a perforated structure, a preferred development of the invention provides an approach wherein the second knitted layer has a first stitch-forming and perforated-structure-generating thread system plus a second stitch-forming thread system, where starting from the exposed surface of the second knitted layer the stitches formed by the first thread system are on the stitches formed by the second thread system and the spacer threads are held on the second knitted layer only by the second thread system. Providing a first thread system and a second thread system enables the above-described advantages to be further reinforced. The stitches lying on the outer surface of the first thread system create optimal protection for the spacer threads that are underneath on the stitches of the second thread system.

As has already been described above, the spacer threads are preferably monofilaments, while the knitted layers can be composed both of monofilament threads and also multifilament threads, multifilament threads allowing a finer, more uniform surface structure to be produced. Especially well-suited are threads composed of polyester, where the especially preferred approach is for both knitted layers and the spacer threads to be entirely composed of polyester threads, thereby also enabling the spacer fabrics to be readily recycled. An especially appropriate polyester is polyethylene terephthalate (PET).

The spacer fabric according to the invention is characterized by improved resistance to wear from mechanical stresses. In a preferred embodiment of the invention, the spacer fabric meets the requirements of the hook-and-loop fastener test according to VDA 230-210 when the exposed surface of the second knitted layer undergoes this test. The spacer fabric meets the requirements of the hook-and-loop fastener test if the grade of 4, preferably, a grade of 5 is achieved.

Due to its resistance to wear, the spacer fabric according to the invention can also be used as a fabric cover layer in highly stressed areas. In addition, however, the fabric has the typical elastic recovery properties of a spacer fabric, as well as a light, open, and breathable structure. The overall thickness can measure, for example, between 2.5 mm and 8 mm for the above applications, although this invention is not restricted to this preferred range.

In order to achieve the densest, strongest, and most robust structure possible, the second knitted layer can be bonded by shrinking the relevant threads at a setting temperature. Yarns are used for this purpose that undergo noticeable shrinkage at an appropriate temperature, with the result that the stitches formed are also pulled tight. If the second generally planar knitted layer is provided with a perforated structure, this approach also yields relatively small uniform holes. In a preferred development of the invention, the yarns for the second knitted layer and the setting temperature are selected so that following the knitting process the yarns of the second knitted layer shrink at least 5%, especially preferably, 10% due to the corresponding effect of the temperature.

The invention also relates to an interior furnishing, such as, for example, a vehicle seat or the interior trim of a vehicle that include the described spacer fabric as cover material. Other possible applications are, for example, the seats or the interior trim of aircraft or rail-based vehicles such as railroads, subways, or the like. Specifically in the case of aircraft, there is a desire to use the lightest possible, most-space-saving possible seats in order to reduce total flying weight and also to have the ability to provide sufficient space for the greatest number of passengers. In addition, the interior furnishing can also relate to an item of furniture such as a chair.

The second generally planar knitted layer then provides the surface of the interior furnishing, that is, in particular, for the motor vehicle seat or motor vehicle interior. Due to the enhanced resistance to wear, even hook-and-loop fasteners, or other rough or sharp-edged objects are not able to damage the interior furnishing item, or at least only able to damage this only very little. In particular, there is no need to provide a multilayer design in which the spacer fabric is covered by a second cover material. Producing this type of interior furnishing, but also the disposal and recycling of the interior furnishing is thus made considerably easier. Finally, it is also possible to reduce production costs since there is no need to use the expensive approach of combining different materials, for which purpose an adhesive is typically used.

Due to its wear-resistant surface, the fabric according to the invention thus provides an additional function in that the additional advantages, specifically, the elastic recovery properties and the breathability are maintained. In particular, the invention enables the resistance to wear, the elastic properties, and the permeability to air to be adapted to and optimized for the specific relevant requirements.

### BRIEF DESCRIPTION OF THE DRAWING

The following describes the invention with reference to a drawing that shows only one illustrated embodiment. Therein:

FIG. 1 is a schematic view of a spacer fabric that includes two generally planar knitted layers which are attached to each other by spacer threads;

FIG. 2 shows the interlacing of the spacer threads in the first generally planar knitted layer;

FIG. 3 shows the interlacing of the spacer threads in the second generally planar knitted layer;

FIG. 4 is another view like FIG. 3;

FIG. 5 is a detail of the surface of the spacer fabric at the second generally planar knitted layer; and

FIG. 6 is a perspective view of a detail of the invention with the knitted layers shown schematically.

### SPECIFIC DESCRIPTION OF THE INVENTION

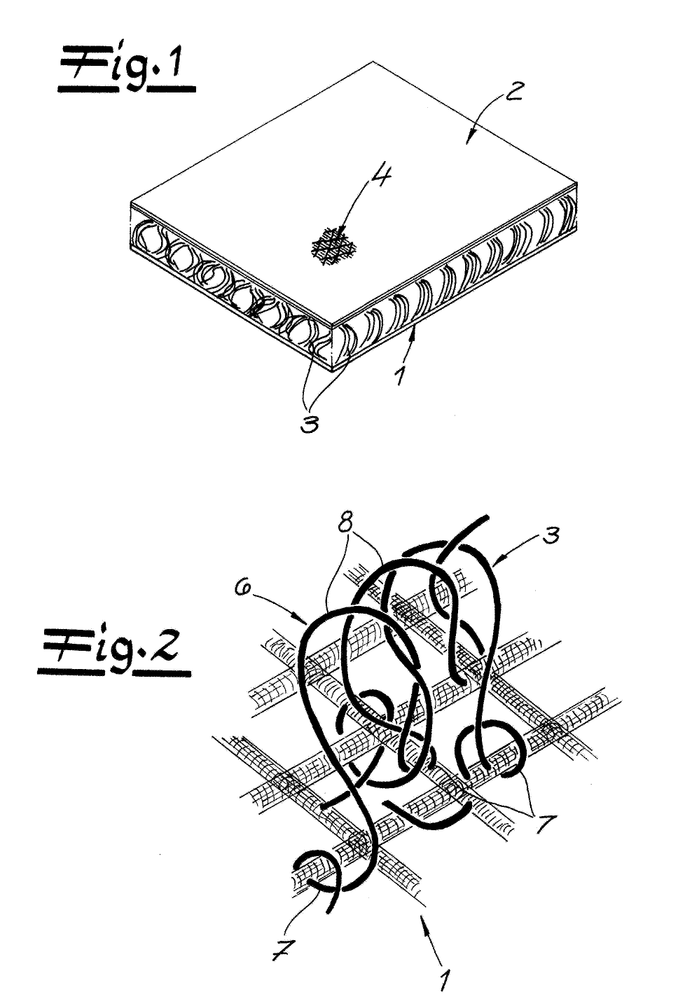

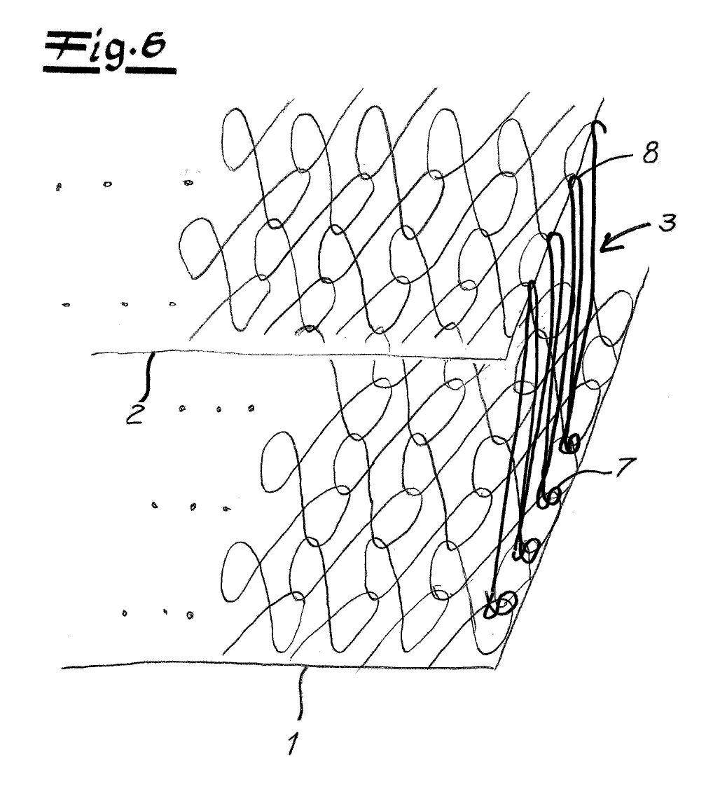

FIG. 1 is a schematic view of a spacer fabric that includes a first generally planar knitted layer 1 and a second generally planar knitted layer 2 that are attached to each other by spacer threads 3. FIG. 1 also clearly reveals that the second knitted layer 2 has a perforated structure with holes 4 covered by weft threads 5 on the inner side facing the first knitted layer 1. The exposed surface of the second knitted layer 2 is also seen in FIG. 5. The weft threads 5 can thus be interlaced such that they do not extend across the entire width of the second knitted layer 2 but only across some of the wales. Depending on the production method, it is possible, however, for the weft threads to be pulled completely through transversely, thereby producing what is known as filling.

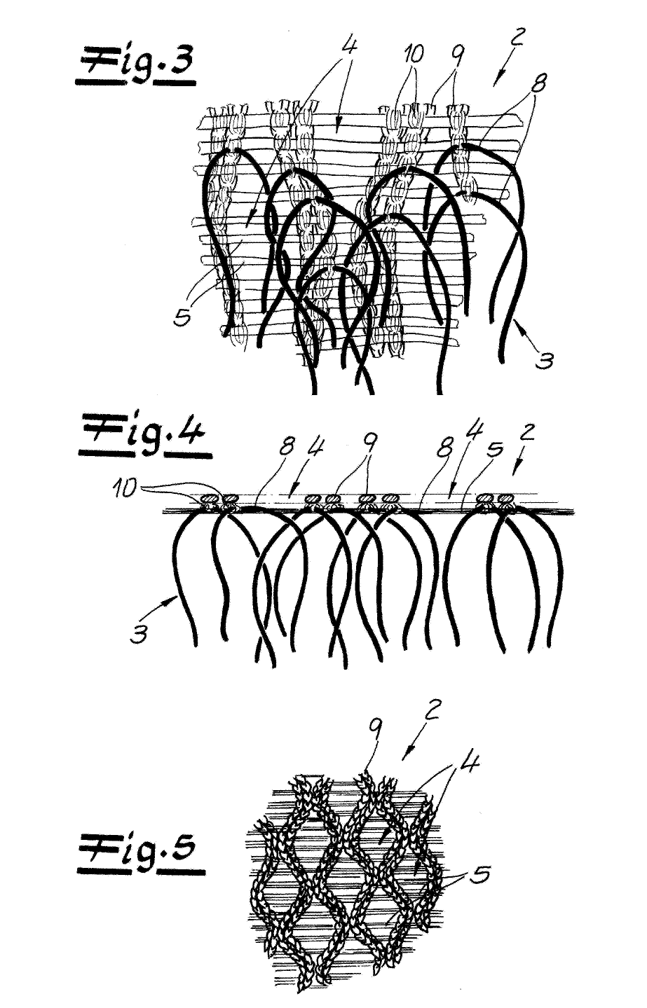

According to the invention as shown in FIGS. 2 and 6, the spacer threads 3 form stitches in the first knitted layer 1 by an intertwining of threads to each other and/or to the threads of the first knitted layer 1. These spacer threads 3 do not form stitches on the second knitted layer 2 but instead are interlaced there only as an inlay (FIGS. 3, 4, and 6). This means that the spacer threads 3 on the second knitted layer 2 are held by at least one associated thread of the second knitted layer with which they are intertwined. For purposes of clarity, the first knitted layer 1 in FIGS. 2 and 6 is shown only in highly schematic fashion. Notwithstanding the highly schematic representation, this in fact is a typical knitted layer composed of stitches forming wales running in the production direction and weft courses transverse thereto. For the sake of simplicity, these wales and stitch courses are shown in FIG. 2 without reproducing the actual courses of the individual stitches of the first knitted layer 1.

A comparison of FIGS. 2, 3, and 6 shows that the spacer threads 3 form pile loops 6 as a result of the described interlacing in the first knitted layer 1 and the second knitted layer 2, these loops each including loop feet 7 created by stitches or knots in the first knitted layer 1 and a loop head 8 between the feet held on the second knitted layer 2. Although the loop head 8 is attached to the second knitted layer 2 as a result of the interlacing of loop head 8 as an inlay, the course of pile loops 6 is nevertheless essentially unchanged by the interlacing in the second knitted layer 2

A critical feature of the invention is that the spacer threads 3 on the second knitted layer 2 run only along the inner face of the layer 2 and are thus not accessible from the exposed face of the second knitted layer 2. The spacer threads 3 on the second knitted layer 2 are thus well protected against mechanical stresses caused by a hook-and-loop fastener or by other hook-like, pointed objects.

The entire spacer fabric can be composed of polyester, in particular, PET. The detail views of FIGS. 2 and 3 show that the spacer threads 3 are monofilaments, whereas the first knitted layer 1 and the second knitted layer 2 are each composed of multifilament yarns.

In the described illustrated embodiment, the second knitted layer 2 includes a first stitch-forming and perforated-structure-generating thread system 9, and a second stitch-forming thread system 10, wherein starting from the exposed surface of the second knitted layer 2 the stitches formed by first thread system 9 are disposed on the stitches formed by second thread system 10, and wherein the spacer threads 3 on the second knitted layer 2 are held only by second thread system 10.

The described measures enable a spacer fabric to be provided that meets the requirements of the hook-and-loop fastener test according to DIN VDA 230-210. The overall thickness of the spacer fabric can measure, for example, between 2.5 mm and 8 mm.

We claim:

1. In a spacer fabric comprising first and second generally planar knitted layers that are attached to each other by spacer threads, the spacer threads forming in the first knitted layer stitches by an intertwining of threads, the improvement wherein the spacer threads do not form stitches in the second generally planar knitted layer and are interlaced there only as an inlay.

2. The spacer fabric according to claim 1, wherein the spacer threads form between the knitted layers pile loops on the first knitted layer that each have loop feet created by stitches and a loop head, the pile loops being held on the loop head on the second knitted layer.

3. The spacer fabric according to claim 1, wherein the second knitted layer has a knit pattern comprising a perforated structure.

4. The spacer fabric according to claim 3, wherein holes of the perforated structure are covered by weft threads on the inside of the second knitted layer.

5. The spacer fabric according to claim 3, wherein the second knitted layer has a first stitch-forming and perforated-structure-generating thread system, and a second stitch-forming thread system, wherein starting from an exposed surface of the second knitted layer the stitches formed by the first thread system are disposed on the stitches formed by the second thread system, and wherein the spacer threads are held on the second knitted layer by the second thread system.

6. The spacer fabric according to that claim 1, wherein the knitted layers and the spacer threads are composed of polyester.

7. The spacer fabric according to claim 1, wherein the overall thickness measures between 2.5 mm and 8 mm.

8. The spacer fabric according to claim 1, wherein the second knitted layer is bonded by shrinking the respective threads at a setting temperature.

9. Interior furnishing item for a motor vehicle seat or motor vehicle interior trim, characterized by a spacer fabric in the form of a cover material according to claim 1.

10. The spacer fabric according to claim 1, wherein the knitted layers and the spacer threads are composed of PET.
